(19) United States
(12) Patent Application Publication
(10) Pub. No.: US 2026/0319947 A1
(43) Pub. Date: Oct. 15, 2026

(54) MEMORY SYSTEMS AND METHODS OF OPERATING THEREOF, ELECTRONIC SYSTEMS AND MEMORY MEDIUMS

(71) Applicant: YANGTZE MEMORY TECHNOLOGIES CO., LTD., Wuhan (CN)

(72) Inventor: Qiang JIANG, Wuhan (CN)

(21) Appl. No.: 19/290,837

(22) Filed: Aug. 5, 2025

(30) Foreign Application Priority Data
Apr. 10, 2025 (CN) 2025104479441

(51) Int. Cl. G06F 12/02

(52) U.S. Cl. CPC G06F 12/0246; G06F 2212/72; G06F 2212/7203

(57) ABSTRACT

A memory system includes a memory device and a memory controller coupled with the memory device. A firmware is run in the memory controller. First configuration information is recorded in the firmware, and is unchangeable content in a profile. The memory controller is configured to: receive a configuration information request command; and in response to the configuration information request command indicating to request information in the first configuration information, send first reply information corresponding to the configuration information request command. The first reply information is independently determined by the memory controller.

### CROSS-REFERENCE TO RELATED APPLICATIONS

The present disclosure claims priority to Chinese Patent Application No. 2025104479441, which was filed Apr. 10, 2025, and is hereby incorporated herein by reference in its entirety.

### TECHNICAL FIELD

Examples of the present disclosure relate to the field of memory technology, and in particular to a memory system and an operation method thereof, an electronic system and a memory medium.

### BACKGROUND

With the development of memory technologies, memory systems have been more widely applied. The memory system comprises a memory device and a memory controller coupled with the memory device, the memory controller can receive a command sent by the host and send reply information corresponding to the command to the host.

In some examples, the memory controller can receive a command related to the profile sent by the host, and in this case, the memory controller needs to send the reply information to the host according to the profile. The profile may refer to a TCG (Trusted Computing Group) profile.

### SUMMARY

Examples of the present disclosure provide a memory system and an operation method thereof, an electronic system and a storage medium. The technical solution is as follows:

According to an aspect, an example of the present disclosure provides a memory system, comprising a memory device and a memory controller coupled with the memory device. A firmware is run in the memory controller. First configuration information is recorded in the firmware, and is unchangeable content in a profile. The memory controller is configured to: receive a configuration information request command; and in response to the configuration information request command indicating to request information in the first configuration information, send first reply information corresponding to the configuration information request command, the first reply information is independently determined by the memory controller.

In some examples, the configuration information request command indicates to request to read information in the first configuration information, and the first reply information comprises the information requested by the configuration information request command to read in the first configuration information; or the configuration information request command indicates to request to change information in the first configuration information, and the first reply information indicates that there is no permission to change the information in the first configuration information.

In some examples, the memory device stores second configuration information, which is changeable content in the profile. The memory controller is further configured to: in response to the configuration information request command indicating to request information in the second configuration information, send second reply information corresponding to the configuration information request command, the second reply information is determined by the memory controller through interaction with the memory device.

In some examples, the memory controller is further configured to: in response to the configuration information request command indicating to request information in the second configuration information, send a read command to the memory device, the read command instructs the memory device to read the second configuration information; receive the second configuration information sent by the memory device, and store the received second configuration information in a buffer memory of the memory controller; and determine the second reply information based on the second configuration information stored in the buffer memory.

In some examples, the configuration information request command indicates to request to read information in the second configuration information, and the second reply information comprises the information requested by the configuration information request command to read in the second configuration information stored in the buffer memory; or the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

In some examples, the memory controller is configured to: in response to the configuration information request command indicating to request to change information in the second configuration information, verify the configuration information request command, and if the verification passes, send the second reply information.

In some examples, the configuration information request command carries first identification information, which is to identify information to be requested by the configuration information request command; and the configuration information request command indicating to request information in the first configuration information comprises: the first identification information matches identification information corresponding to the information in the first configuration information.

In some examples, the profile comprises a TCG profile.

According to another aspect, an example of the present disclosure provides a memory system, comprising a memory device and a memory controller coupled with the memory device. A firmware is run in the memory controller. First configuration information is recorded in the firmware, and is unchangeable content in a profile. The memory controller is configured to: receive a configuration information request command; and in response to the configuration information request command indicating to request information in the first configuration information, send first reply information corresponding to the configuration information request command, the first reply information is independently determined by the memory controller.

In some examples, the configuration information request command indicates to request to read information in the first configuration information, and the first reply information comprises the information requested by the configuration information request command to read in the first configuration information; or the configuration information request command indicates to request to change information in the first configuration information, and the first reply information indicates that there is no permission to change the information in the first configuration information.

In some examples, the memory device stores second configuration information, which is changeable content in the profile. The memory controller is further configured to: in response to the configuration information request command indicating to request information in the second configuration information, send second reply information corresponding to the configuration information request command, the second reply information is determined by the memory controller through interaction with the memory device.

In some examples, the memory controller is further configured to: in response to the configuration information request command indicating to request information in the second configuration information, send a read command to the memory device, the read command instructs the memory device to read the second configuration information; receive the second configuration information sent by the memory device, and store the received second configuration information in a buffer memory of the memory controller; and determine the second reply information based on the second configuration information stored in the buffer memory.

In some examples, the configuration information request command indicates to request to read information in the second configuration information, and the second reply information comprises the information requested by the configuration information request command to read in the second configuration information stored in the buffer memory; or the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

In some examples, the memory controller is configured to: in response to the configuration information request command indicating to request to change information in the second configuration information, verify the configuration information request command, and if the verification passes, send the second reply information.

In some examples, the configuration information request command carries first identification information, which is to identify information to be requested by the configuration information request command; and the configuration information request command indicating to request information in the first configuration information comprises: the first identification information matches identification information corresponding to the information in the first configuration information.

In some examples, the profile comprises a TCG profile.

According to another aspect, an example of the present disclosure provides an electronic system, comprising host; and a memory system coupled with the host. The memory system comprises a memory device and a memory controller coupled with the memory device. A firmware is run in the memory controller. First configuration information is recorded in the firmware, and is unchangeable content in a profile. The host is configured to send a configuration information request command to the memory controller. The memory controller is configured to: receive a configuration information request command; and in response to the configuration information request command indicating to request information in the first configuration information, send first reply information corresponding to the configuration information request command to the host, the first reply information is independently determined by the memory controller. The host is further configured to receive the first reply information.

In some examples, the configuration information request command indicates to request to read information in the first configuration information, and the first reply information comprises the information requested by the configuration information request command to read in the first configuration information; or the configuration information request command indicates to request to change information in the first configuration information, and the first reply information indicates that there is no permission to change the information in the first configuration information.

In some examples, the memory device stores second configuration information, which is changeable content in the profile. The memory controller is further configured to: in response to the configuration information request command indicating to request information in the second configuration information, send second reply information corresponding to the configuration information request command to the host, the second reply information is determined by the memory controller through interaction with the memory device; and the host is further configured to receive the second reply information.

In some examples, the memory controller is further configured to: in response to the configuration information request command indicating to request information in the second configuration information, send a read command to the memory device. The read command instructs the memory device to read the second configuration information. The memory device is configured to: read the second configuration information based on the read command, and send the second configuration information to the memory controller. The memory controller is further configured to: receive the second configuration information sent by the memory device, and store the received second configuration information in a buffer memory of the memory controller; determine the second reply information based on the second configuration information stored in the buffer memory.

In some examples, the configuration information request command indicates to request to read information in the second configuration information, and the second reply information comprises the information requested by the configuration information request command to read in the second configuration information stored in the buffer memory; or the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

In some examples, the memory controller is further configured to: in response to the configuration information request command indicating to request to change the information in the second configuration information, change the second configuration information stored in the buffer memory based on the configuration information request command to obtain the changed second configuration information; and send a write command to the memory device, the write command instructs the memory device to write the changed second configuration information. The memory device is further configured to: write the changed second configuration information based on the write command, and send a write result to the memory controller. The memory controller is further configured to: determine the second reply information based on the write result.

In some examples, the memory controller is further configured to: in response to the configuration information request command indicating to request to change information in the second configuration information, verify the configuration information request command, and if the verification passes, send the second reply information to the host.

In some examples, the configuration information request command carries first identification information, which is to identify information to be requested by the configuration information request command; and the configuration information request command indicating to request information in the first configuration information comprises: the first identification information matches identification information corresponding to the information in the first configuration information.

In some examples, the profile comprises a TCG profile.

According to another aspect, an example of the present disclosure provides a non-transitory computer-readable storage medium, the non-transitory computer-readable storage medium stores firmware, and the firmware is loaded and run by a memory controller in a memory system to cause the memory controller implements the operation method of the memory system of any one of the examples described above.

### BRIEF DESCRIPTION OF THE DRAWINGS

In order to more clearly illustrate the technical solutions in the examples of the present disclosure, the drawings that need to be used in the description of the examples are briefly described below, and obviously, the drawings in the following description are merely some examples of the present disclosure, and for those of ordinary skill in the art, other drawings may be obtained based on these drawings without creative work.

FIG. 1 is a schematic structural diagram of an electronic system provided by an example of the present disclosure.

FIG. 2 is a schematic structural diagram of a memory card provided by an example of the present disclosure.

FIG. 3 is a schematic structural diagram of a solid state disk provided by an example of the present disclosure.

FIG. 4 is a schematic structural diagram of a memory device provided by an example of the present disclosure.

FIG. 5 is a schematic structural diagram of a memory system provided by an example of the present disclosure.

FIG. 6 is a schematic structural diagram of another memory system provided by an example of the present disclosure.

FIG. 7 is a schematic diagram of a storing manner of content in a profile provided by an example of the present disclosure.

FIG. 8 is a schematic diagram of a process of determining reply information by a memory controller provided by an example of the present disclosure.

FIG. 9 is a schematic diagram of another process of determining reply information by a memory controller provided by an example of the present disclosure.

FIG. 10 is a schematic diagram of a process of sending reply information to a host by a memory controller provided by an example of the present disclosure.

FIG. 11 is a flowchart of a method of operating a memory system provided by an example of the present disclosure.

FIG. 12 is a schematic structural diagram of an electronic system provided by an example of the present disclosure.

### DETAILED DESCRIPTION

To make the objectives, technical solutions and advantages of the present disclosure clearer, the examples of the present disclosure are described in detail below with reference to the drawings. While example implementations of the present disclosure are shown in the drawings, it should be understood that the present disclosure may be implemented in various forms and should not be limited by the implementations set forth herein. Rather, these implementations are provided to enable a more thorough understanding of the present disclosure and to fully convey the scope of the present disclosure to those skilled in the art. The drawings all adopt a very simplified form and use a non-precise ratio, which is only used to facilitate and clarify the purpose of the examples of the present disclosure.

It should be noted that the terms “first”, “second”, and the like in the present disclosure are used to distinguish similar objects, and are not necessarily used to describe a specific sequence or order. It should be understood that such used data may be interchanged where appropriate so that examples of the present disclosure described herein can be implemented in an order other than those illustrated or described herein. The implementations described in the following examples do not represent all implementations consistent with the present disclosure. Rather, they are merely examples consistent with some aspects of the present disclosure.

It should be readily understood that the meaning of “on,” “above,” and “over” in the present disclosure should be interpreted in the broadest manner, such that “on” not only means “directly on something,” but also comprises the meaning of “on something” and having an intermediate feature or layer therebetween, and “above” or “over” not only means “above something” or “over something”, but may also comprise “above something” or “over something” and there is no intermediate feature or layer therebetween (e.g., directly on something).

Further, spatially relative terms such as “under,” “below,” “lower,” “above,” “upper,” and the like are used herein for ease of description to describe a relationship as shown in the figures of one element or feature and another element or feature(s). The spatially relative terms are intended to encompass different orientations in device use or operation other than the orientation depicted in the figures. The device may be otherwise oriented (rotated 90 degrees or in other orientations), and the spatially relative descriptors used herein may also be interpreted accordingly.

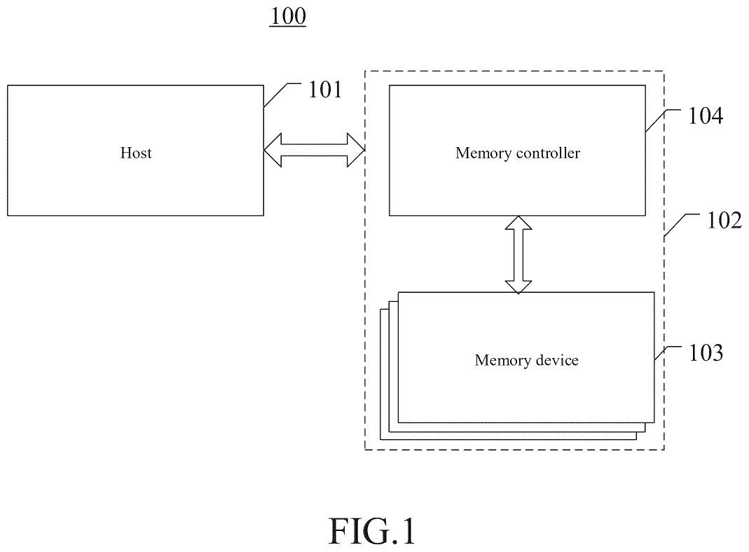

FIG. 1 illustrates a schematic diagram of an electronic system 100 provided by an example of the present disclosure, the electronic system 100 may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a storage device therein.

As shown in FIG. 1, the electronic system 100 includes a host 101 and a memory system 102 coupled to the host 101, and the host 101 may be a processor (for example, a central processing unit (CPU)) or a system on chip (SoC) (for example, an application processor (AP)) of the electronic device. The host 101 may be configured to send data to the memory system 102. Alternatively, the host 101 may be configured to receive data from the memory system 102.

The memory system 102 includes one or more memory devices 103 and a memory controller 104. The memory controller 104 is coupled to the memory device 103, and the memory controller 104 is configured to control the memory device 103. The memory device 103 may be any type of memory. Optionally, the memory device 103 is a NAND (Not AND) flash memory, such as a 3D NAND flash memory; or the memory device 103 is a Dynamic Random Access Memory (DRAM).

For example, the memory controller 104 is also coupled to the host 101. The memory controller 104 may manage data stored in the memory device 103 and communicate with the host 101.

In one possible implementation, the memory controller 104 is designed to operate in a low duty cycle environment, such as a Secure Digital (SD) card, a Compact Flash (CF) card, a Universal Serial Bus (USB) flash drive, or other medium for use in electronic devices such as personal computers, digital cameras, mobile phones, and the like.

In one possible implementation, the memory controller 104 is designed to operate in a high duty cycle environment, for example, a Solid State Disk (SSD) or an Embedded Multi Media Card (eMMC). SSD or eMMC are used as data memory for mobile devices such as smartphones, tablets, laptops, and the like, as well as enterprise memory arrays.

The memory controller 104 may be configured to control operations of the memory device 103, such as read, erase, and program operations. The memory controller 104 may also be configured to manage various functions regarding data stored in or to be stored in the memory device 103, including, but not limited to, bad block management, garbage collection, logical-to-physical address translation, wear leveling, and the like. In one possible implementation, the memory controller 104 is further configured to process error correction code (ECC) regarding data read from or written to the memory device 103. In some examples of the present disclosure, the memory controller 104 is configured to send reply information corresponding to the configuration information request command to the host 101.

The memory controller 104 may also perform any other suitable function, such as formatting the memory device 103. The memory controller 104 may communicate with an external device (e.g., the host 101) according to a particular communication protocol. For example, the memory controller 104 may communicate with an external device through at least one of various interface protocols, such as a USB protocol, a Multi Media Card (MMC) protocol, a Peripheral Component Interconnect (PCI) protocol, a PCI Express (PCI-E) protocol, an Advanced Technology Attachment (ATA) protocol, a Serial ATA (SATA) protocol, a parallel ATA protocol, a Small Computer System Interface (SCSI) protocol, an Enhanced Small Drive Interface (ESDI) protocol, an Integrated Drive Electronics (IDE) protocol, a Firewire protocol, a Non-Volatile Memory express (NVMe) protocol, and the like.

The memory controller 104 and the one or more memory devices 103 may be integrated into various types of memory systems 102, e.g., included in the same package (e.g., Universal Flash Memory (UFS) package or eMMC package). For example, the memory system 102 may be implemented and packaged into different types of terminal electronics.

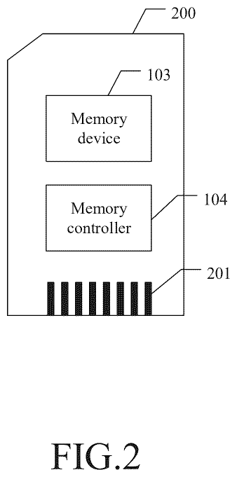

For example, as shown in FIG. 2, the memory controller 104 and the single memory device 103 may be integrated into the memory card 200. The memory card 200 may include a PC card (Personal Computer Memory Card International Association, PCMCIA, abbreviated as PC), a CF card, a smart media (SM) card, a memory stick, a multimedia card (MMC, RS-MMC (Reduced-Size MMC), an MMCmicro (micro multimedia card)), an SD card (SD, miniSD (small secure digital memory card), a microSD (micro secure digital memory card), an SDHC (Secure Digital High Capacity)), a UFS, and the like. The memory card 200 may also include a memory card connector 201 that couples the memory card 200 with a host (e.g., host 101 in FIG. 1).

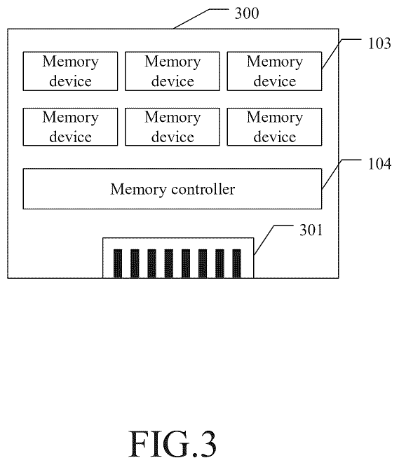

For example, as shown in FIG. 3, the memory controller 104 and the plurality of memory devices 103 may be integrated into a solid state disk (also referred to as a solid state drive) 300. The solid state disk 300 may also include a solid state disk connector 301 that couples the solid state disk 300 with a host (e.g., host 101 in FIG. 1). In one possible implementation, a memory capacity and/or an operating speed of the solid state disk 300 is greater than a memory capacity and/or an operating speed of the memory card 200.

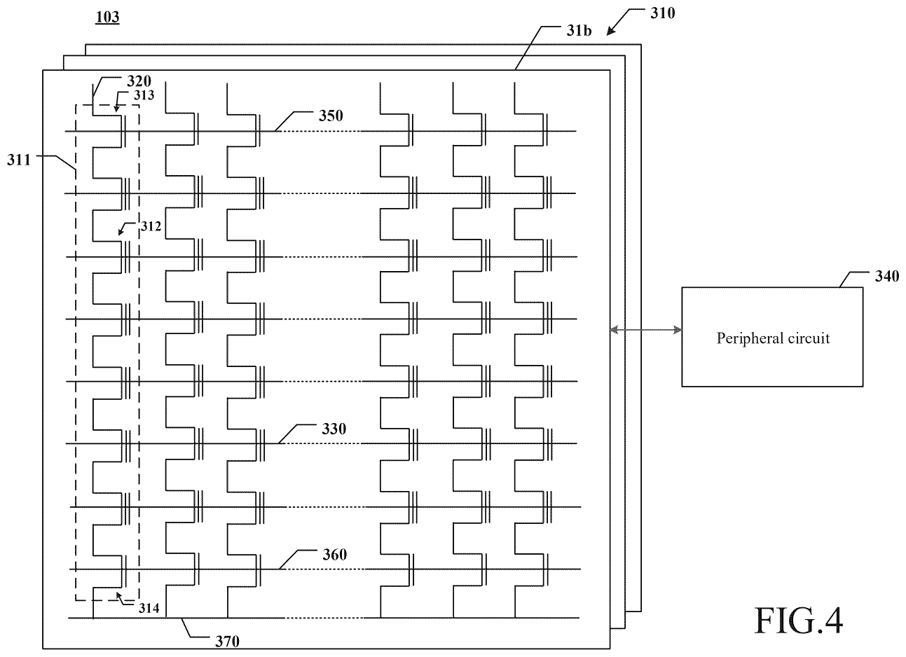

FIG. 4 shows a schematic diagram of a memory device provided by an example of the present disclosure. As shown in FIG. 4, the memory device 103 includes a memory array 310 and a peripheral circuit 340 communicatively connected to the memory array 310.

The memory array 310 includes a plurality of memory strings 311 arranged in an array on a bearing side of a substrate (not shown) and extending in a direction perpendicular to a bearing surface of the substrate. For example, the bearing surface of the substrate refers to a surface of the substrate that is configured to bear the memory array 310.

Each memory string 311 includes a plurality of memory cells 312, and a plurality of memory cells 312 in each memory string 311 are stacked in a direction perpendicular to the bearing surface of the substrate. Each memory cell 312 has a function of storing data, the stored data is determined by the number of electrons stored in the memory cell 312, and the number of electrons stored in the memory cell 312 can determine the magnitude of the threshold voltage of the memory cell 312, so the threshold voltage of the memory cell 312 can indicate the data stored therein. The memory cell 312 is a floating gate field effect transistor or a charge trap type field effect transistor.

For example, the memory cell 312 may be a single level cell (SLC), a multi-level cell (MLC), a triple level cell (TLC), or a quad level cell (QLC), and the like. SLC, MLC, TLC, and QLC are capable of storing 1, 2, 3 and 4 bits of data, respectively.

Each memory string 311 also includes an upper select transistor 313 and a lower select transistor 314, and upper select transistors 313 with the same height or similar height from the bearing surface of the substrate in different memory strings 311 are coupled to the same drain select line (DSL) 350. The lower select transistors 314 with the same height or similar height from the bearing surface of the substrate in different memory strings 311 are coupled to the same source select line (SSL) 360. The upper select transistor 313 and the lower select transistor 314 are configured to activate the selected memory string when reading, programming, or erasing the memory cell. The upper select transistor 313 is also referred to as a top select gate (TSG), and the lower select transistor 314 is also referred to as a bottom select gate (BSG). For example, there is also a dummy cell (DC) between the upper select transistor 313 and the memory cell 312, and between the lower select transistor 314 and the memory cell 312.

One end of the memory string 311 is coupled to a bit line (BL) 320, and the other end of the memory string 311 is coupled to a source line (SL) 370.

The memory cells 312 with the same height or similar height from the bearing surface of the substrate in different memory strings 311 are in the same layer, and the memory cells 312 in the same layer form a memory cell layer, for example, the memory array 310 includes a plurality of memory cell layers, and the plurality of word lines 330 are respectively coupled to the plurality of memory cell layers.

All memory strings 311 sharing a same set of word lines in the memory array 310 form a memory block 31b. Each memory block 31b includes a plurality of memory pages, the memory page is the smallest unit of read and program (also referred to as write), and the memory block 31b is the smallest unit of erase.

In some examples, the source ends of the memory strings 311 in the same memory block 31b are coupled to the same source line 370, which is also referred to as a common source line (CSL). In other words, the memory strings 311 in the same memory block 31b have an array common source (“ACS”). A source end of the memory string 311 refers to an end of the memory string 311 for coupling with the source line 370.

Peripheral circuit 340 may be coupled to memory array 310 through drain select line 350, source select line 360, bit line 320, source line 370, and word line 330. Peripheral circuit 340 may include any suitable analog, digital, and mixed-signal circuit for facilitating operation of memory array 310 by applying voltage signals and/or current signals to memory cells 312 and sensing voltage signals and/or current signals from memory cells 312 via drain select lines 350, source select lines 360, bit lines 320, source lines 370, and word lines 330.

The peripheral circuit 340 may include various types of peripheral circuits formed using metal-oxide-semiconductor (MOS) technology. The peripheral circuit 340 can control the memory cell 312 in the selected memory string by controlling the voltage of the word line 330 to which the selected memory string is coupled and the voltage of the bit line 320 to which the selected memory string is coupled, to implement operations such as erase, program, read, or verify.

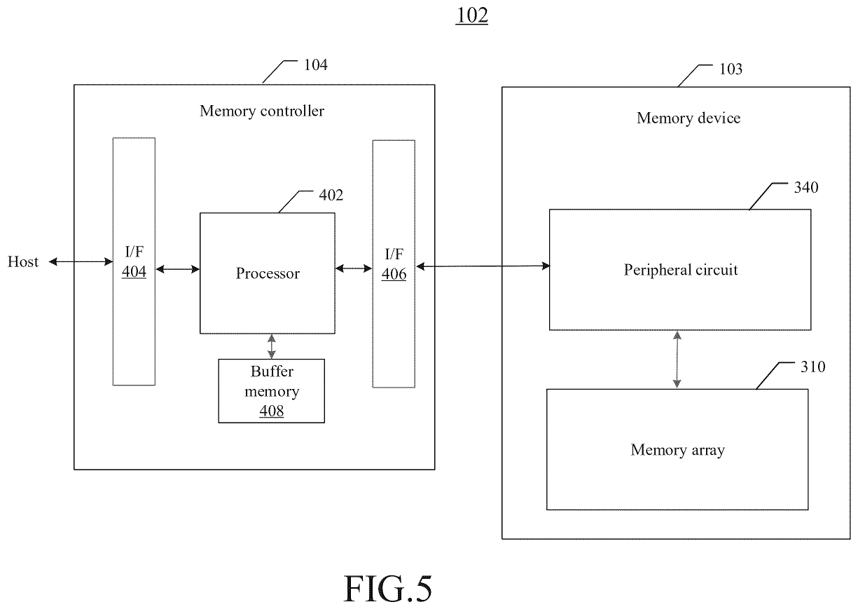

FIG. 5 shows a schematic diagram of a memory system provided by an example of the present disclosure. The memory system 102 includes a memory device 103 and a memory controller 104 coupled with the memory device 103. The memory device 103 includes a memory array 310 and peripheral circuit 340 communicatively connected with the memory array 310.

The memory controller 104 includes a processor 402, an I/F (Interface) 404, an I/F 406, and a buffer memory 408. The processor 402 is a core of the memory controller 104, and is responsible for processing an instruction sent by the host, and scheduling the operations of the memory device 103 according to the instruction. The I/F 404 is configured to implement communication between the memory controller 104 and the host, and the I/F 406 is configured to implement communication between the memory controller 104 and the memory device 103. The buffer memory 408 is configured to temporarily store data to improve data access speed.

In the structure of the memory system shown in FIG. 5, the data reading process includes: the host sends a read command to the memory controller 104 through the I/F 404; after receiving the read command, the processor 402 of the memory controller 104 first queries the buffer memory 408. If there is data to be read in the buffer memory 408, the processor 402 reads the data from the buffer memory 408 directly, and returns the data to the host through the I/F 404. If there is no data to be read in the buffer memory 408, the processor 402 sends a read command to the memory device 103 through the I/F 406. After receiving the read command, the peripheral circuit 340 of the memory device 103 decodes the address in the read command, locates the corresponding memory location in the memory array 310 and reads the data from the corresponding memory location, and the peripheral circuit 340 transmits the read data back to the memory controller 104 through the I/F 406. The processor 402 in the memory controller 104 stores the data in the buffer memory 408 for subsequent re-access while sending data to the host through the I/F 404.

The data writing process includes: the host prepares the data to be written and the corresponding memory address, and sends a write command to the memory controller 104 through the I/F 404. The processor 402 of the memory controller 104 receives a write command, temporarily stores the data to be written in the buffer memory 408 while sending a write command to the memory device 103 through the I/F 406, the write command includes information about data to be written and the memory address into which the data is to be written. After receiving the write command, the peripheral circuit 340 of the memory device 103 decodes the memory address to find the corresponding memory location in the memory array 310, and then writes the data to be written into the memory location. After completing the data writing operation, the peripheral circuit 340 feeds back a write complete signal to the memory controller 104. After receiving the feedback, the processor 402 in the memory controller 104 confirms that the data has been successfully written into the memory device 103, and feeds back a write complete signal to the host through the I/F 404.

With the development of memory technologies, the memory system has been more widely applied. The memory system includes a memory device and a memory controller coupled with the memory device, the memory controller can receive a command sent by the host and send the reply information corresponding to the command to the host.

In some examples, the memory controller can receive a command related to the profile sent by the host, and in this case, the memory controller needs to send the reply information to the host according to the profile.

In an example, the profile is stored as a whole in the memory device without distinction, and after the host sends the command related to the profile, the memory controller needs to load all of the profile into an internal memory device, and then determine and send the reply information according to the content in the internal memory device.

The profile is relatively large, for example, the profile may need to occupy memory space of 128 KB (kilobytes), and loading all of the profile into the internal memory device will consume many internal memory resources, and the loading speed is relatively slow, resulting in lower efficiency of sending the reply information, thereby resulting in lower efficiency of interacting between the memory system and the host.

In addition, in some examples, the memory space in the memory device inside the memory controller is a fragmentation space, for example, the fragmentation space in units of 4 KB, and in this case, the large memory space for storing the memory profile is difficult to request, and the more the memory space is requested, the greater the difficulty of managing the memory space, the greater the probability of conflicting with other operations that need to use the memory space, thereby easily causing the memory system not functioning properly or working incorrectly. In some examples, other operations that utilize memory space may refer to operations of a flash translation layer (FTL), where the primary task of the FTL is to translate between a logical address space used by the host and a physical address space used by the memory device, and the FTL also has various functions for managing data stored in or to be stored in the memory device, including but not limited to bad block management, garbage collection, logical-to-physical address translation, wear leveling, error correction, and the like.

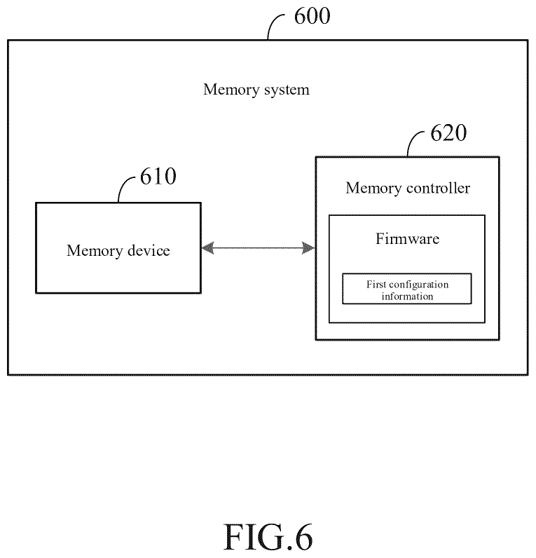

An example of the present disclosure provides a memory system, as shown in FIG. 6, the memory system 600 includes a memory device 610 and a memory controller 620 coupled with the memory device 610. The memory system 600 may be the memory system 102 in FIG. 1 and FIG. 5, the memory device 610 may be the memory device 103 in FIGS. 1 to 5, and the memory controller 620 may be the memory controller 104 in FIGS. 1 to 3 and FIG. 5.

In some examples of the present disclosure, a firmware is run in the memory controller 620, first configuration information is recorded in the firmware, and is unchangeable content in the profile; the memory controller 620 is configured to: receive a configuration information request command; and in response to the configuration information request command indicating to request information in the first configuration information, send first reply information corresponding to the configuration information request command, where the first reply information is independently determined by the memory controller 620.

Firmware is a software embedded in hardware, unlike application software typically running on a computer operating system, the firmware is customized to a particular hardware for controlling and managing the basic functions and operations of the hardware. The firmware involved in the examples of the present disclosure is software for controlling and managing basic functions and operations of the memory controller 620, and the firmware includes a series of instructions capable of coordinating communication between the memory controller 620 and the host and the memory device 610. In some examples, the instructions in the firmware are presented in the form of program code.

Before the memory controller 620 runs the firmware, a loading process of the firmware needs to be executed first. For example, the firmware is stored in the memory device 610 by default, and when the memory controller 620 is started, the memory controller 620 first executes an initialization program. This initialization program directs the memory controller 620 to read the firmware from the memory device 610 and load the firmware into the buffer memory in the memory controller 620. The buffer memory in the memory controller 620 is a hardware that is internal to the memory controller 620 and has a memory function, and the buffer memory in the memory controller 620 has a faster read/write speed than the memory device 610. The type of the buffer memory in the memory device 610 and the memory controller 620 is not limited in some examples of the present disclosure. For example, the type of the memory device 610 is NAND, and the type of the buffer memory in the memory controller 620 is Random Access Memory (RAM).

When the firmware is successfully loaded into the buffer memory, the memory controller 620 starts running the firmware, for example, executing the instructions in the firmware. The memory controller 620 sequentially reads and parses the instructions according to the logical sequence of the firmware, and performs corresponding operations according to the requirements of the instructions. For example, the memory controller 620 includes a processor, and the running of the firmware by the memory controller 620 refers to the running of the firmware by the processor in the memory controller 620.

In some examples, after the memory controller 620 successfully loads the firmware from the memory device 610 into the buffer memory, the firmware stored in the memory device 610 is not erased to ensure that the firmware is always backed up in the memory device 610, so that the firmware backed up in the memory device 610 can serve as a reliable recovery source when the firmware running in the memory controller 620 is damaged or lost due to various reasons (such as hardware faults, software errors, unexpected power loss, etc.).

In some examples of the present disclosure, the firmware is run in the memory controller 620, for example, the memory controller 620 has successfully loaded the firmware from the memory device 610 into the buffer memory, and has started running the firmware.

In some examples of the present disclosure, first configuration information is recorded in the firmware run by the memory controller 620, where the first configuration information refers to unchangeable content in the profile. The profile is a file that sets and describes parameters, functions, component relationships, and the like of the memory system 600, and plays a key role in the normal operation, performance optimization and management of the memory system 600. The host can read or change some of the information in the profile through interaction with the memory system 600.

The type of the profile is not limited in some examples of the present disclosure, and for example, the profile includes the TCG profile. The TCG profile is a series of specification documents formulated by the TCG, and is to define and standardize the standards of the components, interfaces, operation procedures, and the like related to trusted computing technology, to implement the credibility and security of the computing platform. The TCG profile enables trusted computing products developed by different manufacturers to be mutually compatible and to work cooperatively, and provides a unified standard and guidance for constructing a safe and reliable computing environment. The specification applicable to the TCG profile is not limited in some examples of the present disclosure, and for example, the specification applicable to the TCG profile may be an Opal specification or a Pyrite specification, or the like. Both the Opal specification and the Pyrite specification are specifications formulated by the TCG. Both the Opal specification and the Pyrite specification are to enhance the security and credibility of the computing environment, but differ in specific functions and application scenarios, where the Pyrite specification is more focused on the specification of specific functions such as data deletion of the memory system 600, and the Opal specification covers more extensive functions such as encryption and identity verification.

The profile includes changeable content and unchangeable content. The changeable content and the unchangeable content in the profile may be preset by the provider of the profile, and the provider of the profile may set the changeable content and the unchangeable content in the profile by comprehensively considering various factors including the stability, security, hardware characteristics, software compatibility, and manufacturer specifications and the like of the memory system 600, which is not limited in the examples of the present disclosure.

For example, the key parameters related to the core architecture and the basic operation mechanism of the memory system 600 are unchangeable, for example, the underlying data memory format of the memory system 600, the basic communication protocol setting of the hardware interface, and the like. Some performance optimization parameters that have less impact on the stability of the memory system 600 may be set to be changeable, for example, some parameters related to the cache, such as cache size, replacement policy of cached data, and the like.

For example, key configuration information related to the security authentication and authorization mechanism of the memory system 600 is unchangeable, for example, the root key of the memory system 600, the certificate configuration of the authentication center, and the like. Part of security-related content such as access permission setting of the user level is changeable, for example, file access permission of the ordinary user, read-write permission of the specific user group, and the like.

For example, the configuration related to the hardware inherent attribute of the memory system 600 is unchangeable, for example, the physical capacity of the hard disk, the type and specification of the memory device 610, etc. Some parameters related to the hardware working mode but adjustable by software is changeable, for example, an energy-saving mode setting of a hard disk, a performance optimization mode selection of a solid state disk, and the like.

For example, each content in the profile has an identification for indicating whether the content is changeable, and whether each content in the profile is changeable content or unchangeable content can be distinguished according to the identification.

In some examples, for a case where the profile is a TCG profile, the unchangeable content in the TCG profile may include, but is not limited to, a Unique Identifier (UID), an Storage Security Command (SSC) version information, and an Access Control List (ACL); the changeable content in the TCG profile may include, but is not limited to, a Personal Identification Number (PIN), a number of tries of the PIN, and association information of the locking range.

The UID is to uniquely identify a certain content in the TCG profile. The SSC version information records version number of functions related to memory security commands, and different SSC versions may have different functional characteristics, security mechanisms, and management capabilities for the memory system 600. An ACL is to define access rights to particular resources, and in the TCG profile, the ACL specifies which users or groups of users are capable of accessing particular memory resources or performing particular operations. The PIN is a personal identification code set by the user for identity verification, and when the user accesses the protected resource or performs a specific operation, it is necessary to enter a correct PIN to pass verification.

The number of attempt of the PIN records the number of times the PIN is attempt ed to be entered, usually a permissible upper limit of the number of attempts is set, and when the number of times that the user enters the wrong PIN reaches this upper limit, the memory system 600 may take some measures, such as locking the device or restricting further access tries, to prevent security threats such as brute force cracking. The locking range is to define the range of locking, for example, the locking range may specify a locked memory area. The association information of the locking range is information related to the locking range, and based on the association information of the locking range, the data of the specific area can be protected from unauthorized access or modification. The user can enable the user to set passwords, check permissions, set range access permissions, and the like according to the information in the acquired TCG profile.

In some examples of the present disclosure, the unchangeable content in the profile is referred to as first configuration information, the changeable content in the profile is referred to as second configuration information, the first configuration information is recorded in the firmware, and the second configuration information is stored in the memory device 610. In some examples, the second configuration information is stored in a fixed area in the memory device 610, and the location of the fixed area in the memory device 610 may be flexibly set.

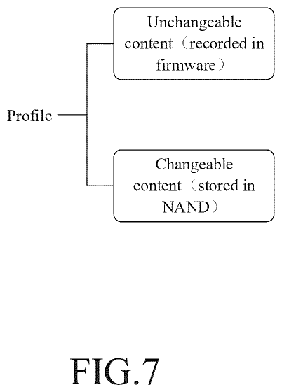

For example, taking the memory device 610 being NAND as an example, the contents in the profile may be stored as shown in FIG. 7. The content in the profile is divided into unchangeable content and changeable content, the unchangeable content is recorded in firmware (e.g., written in program code in firmware), and the changeable content is stored in the NAND.

Based on this, after the memory controller 620 runs the firmware, the memory controller 620 can directly obtain the first configuration information from the running firmware, for example, the memory controller 620 does not need to interact with the memory device 610 to obtain the first configuration information. In some examples, the obtaining, by the memory controller 620, the first configuration information directly from the running firmware means that the obtaining, by the processor in the memory controller 620, the first configuration information directly from the running firmware.

Based on the firmware being run in the memory controller 620 and the first configuration information being recorded in the firmware, the memory controller 620 can receive the configuration information request command; and in response to the configuration information request command indicating to request the information in the first configuration information, send first reply information corresponding to the configuration information request command, the first reply information is independently determined by the memory controller 620.

The configuration information request command is a command sent by the host for requesting information in the profile. The occasion when the host sends the configuration information request command to the memory controller 620 is not limited in some examples of the present disclosure, and after the host sends the configuration information request command to the memory controller 620, the memory controller 620 receives the configuration information request command. In some examples, the memory controller 620 has a first interface through which the memory controller 620 receives the configuration information request command, the first interface is an interface that the memory controller 620 has for communicating with the host.

The type of the configuration information request command is not limited in some examples of the present disclosure, and for example, the type of the configuration information request command may be a request-to-read type or a request-to-change type. When the type of the configuration information request command is the request-to-read type, the configuration information request command requests to read the information in the profile; and when the type of the configuration information request command is the request-to-change type, the configuration information request command requests to change the information in the profile.

In some examples, the configuration information request command has a field for identifying the type of the configuration information request command, and the memory controller 620 can determine the type of the configuration information request command according to the field. For example, if the field is GET, it indicates that the type of the configuration information request command is the request-to-read type; and if the field is the SET, it indicates that the type of the configuration information request command is the request-to-change type.

After receiving the configuration information request command, the memory controller 620 can determine whether the configuration information request command indicates to request the information in the first configuration information.

In some examples, the configuration information request command carries first identification information, which is to identify the information to be requested by the configuration information request command. Based on this, the manner in which the memory controller 620 determines whether the configuration information request command indicates to request the information in the first configuration information may include: the memory controller 620 compares the first identification information with the identification information corresponding to the information in the first configuration information, and determines that the configuration information request command indicates to request the information in the first configuration information if the first identification information matches the identification information corresponding to the information in the first configuration information; and determines that the configuration information request command does not indicate to request the information in the first configuration information if the first identification information does not match the identification information corresponding to the information in the first configuration information. In other words, the configuration information request command indicating to request the information in the first configuration information includes: the first identification information matches the identification information corresponding to the information in the first configuration information.

Because the first configuration information is recorded in the firmware running in the memory controller 620, and the information in the first configuration information has respective identification information, the memory controller 620 can learn identification information corresponding to the information in the first configuration information, so that the first identification information can be compared with the identification information corresponding to the information in the first configuration information. For example, the memory controller 620 may independently perform a process of determining whether the configuration information request command indicates to request the information in the first configuration information. It should be noted that the configuration information request command indicating to request the information in the first configuration information mentioned in some examples of the present disclosure refers to the configuration information request command indicating to only request the information in the first configuration information.

The type of the identification information is not limited in some examples of the present disclosure, as long as the information can be identified, for example, the identification information may refer to the UID. For example, the information in the profile is recorded in a form of a table, and the identification information may refer to a location where the information is recorded in the table.

In some examples, the information to be requested by the configuration information request command may include one or more pieces of information, the number of the first identification information is the same as the number of the information to be requested by the configuration information request command, for example, the number of the first identification information may be one or more.

In some examples, the first identification information matching the identification information corresponding to the information in the first configuration information refers to each of the first identification information hitting identification information corresponding to the information in the first configuration information. One of the first identification information hitting identification information corresponding to the information in the first configuration information refers to one of the first identification information being the same as the identification information corresponding to any of the information in the first identification information.

When it is determined that the configuration information request command indicates to request the information in the first configuration information, the memory controller 620 independently determines the first reply information corresponding to the configuration information request command, and sends the first reply information to the host. The first reply information refers to the reply information fed back by the memory controller 620 to the host when the configuration information request command indicates to request the information in the first configuration information.

The memory controller 620 independently determining the first reply information refers to that the memory controller 620 determines the first reply information by itself without interacting with other devices. In other words, the memory controller 620 independently completes the determination of the first reply information by virtue of its own capabilities without relying on other devices. When the type of the configuration information request command is different, the manner in which the memory controller 620 determines the first reply information is also different.

When the type of the configuration information request command is the request-to-read type, the configuration information request command indicating to request the information in the first configuration information refers to the configuration information request command indicating to request to read the information in the first configuration information. When the configuration information request command indicates to request to read the information in the first configuration information, the manner in which the memory controller 620 determines the first reply information is as follows: extracting, by the memory controller 620, the information requested by the configuration information request command to read from the first configuration information, and forming the first reply information based on the extracted information. In other words, the first reply information includes information requested by the configuration information request command to read in the first configuration information.

The memory controller 620 can determine the information requested by the configuration information request command to read according to the first identification information carried in the configuration information request command, and then extract the information requested by the configuration information request command to read from the first configuration information recorded in the running firmware.

When the type of the configuration information request command is the request-to-change type, determining that the configuration information request command indicates to request the information in the first configuration information refers to the configuration information request command indicating to request to change the information in the first configuration information. When the configuration information request command indicates to request to change the information in the first configuration information, because the first configuration information is unchangeable content in the profile, the manner in which the memory controller 620 determines the first reply information is as follows: using, by the memory controller 620, the reply information for indicating that there is no permission to change the information in the first configuration information as the first reply information. In other words, the first reply information indicates that there is no permission to change the information in the first configuration information.

The form of the first reply information is not limited in some examples of the present disclosure, as long as it is ensured that the host can extract the information that needs to be read from the first reply information, or that the host can learn that there is no permission to change the information in the first configuration information. based on the first reply information. For example, a form of the first reply information may be a message.

In some examples, there may be two cases where the configuration information request command does not indicate to request the information in the first configuration information: the configuration information request command indicates to request information in the second configuration information; and the configuration information request command indicates to request the information in the first configuration information and information in the second configuration information. It should be noted that the configuration information request command indicating the information in the second configuration information mentioned in some examples of the present disclosure refers to the configuration information request command indicating to only request the information in the second configuration information.

For example, when the number of the first identification information is one, if this first identification information does not hit the identification information corresponding to the information in the first configuration information, it may be determined that the configuration information request command indicates to request the information in the second configuration information. When there are a plurality of first identification information, if each of first identification information in the plurality of first identification information does not hit the identification information corresponding to the information in the first configuration information, it may be determined that the configuration information request command indicates to request the information in the second configuration information; and if some of the first identification information of the plurality of first identification information hit the identification information corresponding to the information in the first configuration information, and some of the first identification information does not hit the identification information corresponding to the information in the first configuration information, it may be determined that the configuration information request command indicates to request the information in the first configuration information and the information in the second configuration information. First identification information hitting the identification information corresponding to the information in the first configuration information refers to this identification information being the same as the identification information corresponding to any of information in the first identification information; and first identification information not hitting the identification information corresponding to the information in the first configuration information refers to this identification information not being the same as the identification information corresponding to each of information in the first identification information.

In some examples, the memory controller 620 is further configured to: in response to the configuration information request command indicating to request information in the second configuration information, send second reply information corresponding to the configuration information request command, the second reply information is determined by the memory controller 620 through interaction with the memory device 610. The second reply information is the reply information sent by the memory controller 620 to the host when the configuration information request command indicates to request the information in the second configuration information.

In other words, when the configuration information request command indicates to request the information in the second configuration information, the memory controller 620 determines the second reply information through interaction with the memory device 610, and then sends the second reply information to the host.

In some examples, the memory controller 620 is configured to determine the second reply information by performing the following operations: in response to the configuration information request command indicating to request the information in the second configuration information, sending a read command to the memory device 610, the read command instructs the memory device 610 to read the second configuration information; receiving the second configuration information sent by the memory device 610, and storing the received second configuration information in the buffer memory of the memory controller 620; and determining the second reply information based on the second configuration information stored in the buffer memory. The buffer memory is a hardware that is internal to the memory controller 620 and has a memory function, and the buffer memory has a faster read/write speed than the memory device 610. For example, a type of the buffer memory is a Random Access Memory (RAM).

When the configuration request command indicates to request the information in the second configuration information, because the second configuration information is stored in the memory device 610, the memory controller 620 cannot directly determine the second reply information, but needs to load the second configuration information into the internal buffer memory from the memory device 610 firstly, and then can determine the second reply information according to the second configuration information in the buffer memory. The process of the memory controller 620 loading the second configuration information from the memory device 610 into the internal buffer memory is implemented by interacting with the memory device 610. The interaction process includes: the memory controller 620 sends a read command to the memory device 610, the read command instructs the memory device 610 to read the second configuration information; the memory device 610 reads the second configuration information based on the read command, and sends the second configuration information to the memory controller 620; and the memory controller 620 receives the second configuration information sent by the memory device 610, and stores the received second configuration information in the buffer memory.

The read command carries read address information, the read address information is configured to indicate a memory location of the second configuration information in the memory device 610, the memory device 610 can read the second configuration information according to the read address information, and then send the second configuration information to the memory controller 620. For example, the memory device 610 includes a peripheral circuit and a memory array, the memory location indicated by the read address information refers to a memory location in the memory array, the peripheral circuit in the memory device 610 can receive the read command, parse the read address information from the read command, and read the second configuration information in the memory array according to the read address information.

In some examples, after receiving the second configuration information, the memory controller 620 stores the second configuration information in the target memory space in the buffer memory. The target memory space refers to a memory space in the buffer memory in which data is not stored and whose capacity is greater than or equal to a memory capacity required by the second configuration information. In some examples, the memory controller 620 includes a processor configured to run firmware and a management unit configured to manage memory space in the buffer memory. For example, storing, by the memory controller 620, the second configuration information in the target memory space in the buffer memory refers to storing, by the processor in the memory controller 620, the second configuration information in the target memory space in the buffer memory.

Before storing the second configuration information in the target memory space in the buffer memory, the processor sends a memory space application request to the management unit, the memory space application request carries the target capacity, and the target capacity is greater than or equal to the memory capacity required by the second configuration information; the management unit determines the target memory space of the target capacity in the memory space in the buffer memory according to the memory space application request, and feeds back the address information of the target memory space to the processor; and the processor determines the target memory space according to the address information of the target memory space, and stores the second configuration information in the target memory space in the buffer memory after receiving the second configuration information.

After storing the second configuration information in the buffer memory, the memory controller 620 determines the second reply information based on the second configuration information stored in the buffer memory. When the type of the configuration information request command is different, the manner in which the memory controller 620 determines the second reply information is different.

When the type of the configuration information request command is the request-to-read type, the configuration information request command indicating to request the information in the second configuration information refers to the configuration information request command indicating to request to read the information in the second configuration information. When the configuration information request command indicates to request to read the information in the second configuration information, the manner in which the memory controller 620 determines the second reply information is as follows: extracting, by the memory controller 620, the information requested by the configuration information request command to read from the second configuration information stored in the buffer memory, and forming the second reply information based on the extracted information. In other words, the second reply information includes information requested by the configuration information request command to read in the second configuration information stored in the buffer memory.

The memory controller 620 can determine the information requested by the configuration information request command to read according to the first identification information carried in the configuration information request command, and then extract the information requested by the configuration information request command to read from the second configuration information stored in the buffer memory.

When the type of the configuration information request command is the request-to-change type, the configuration information request command indicating to request the information in the second configuration information refers to the configuration information request command indicating to request to change the information in the second configuration information. When the configuration information request command indicates to change the information in the second configuration information, the manner in which the memory controller 620 determines the second reply information is as follows: changing, by the memory controller 620, the second configuration information stored in the buffer memory based on the configuration information request command to obtain changed second configuration information; sending a write command to the memory device 610, the write command instructs the memory device 610 to write the changed second configuration information; writing, by the memory device 610, the changed second configuration information based on the write command, and sending a write result to the memory controller 620; and determining, by the memory controller 620, the second reply information based on the write result. In other words, when the configuration information request command indicates to change the information in the second configuration information, the second reply information indicates the write result of writing the changed second configuration information into the memory device 610, and the changed second configuration information is obtained by changing the second configuration information stored in the buffer memory based on the configuration information request command.

When the configuration information request command indicates to request to change the information in the second configuration information, the configuration information request command carries content used to indicate a manner in which the information to be changed in the second configuration information is changed, and the memory controller 620 can change the information to be changed in the second configuration information stored in the buffer memory based on the configuration information request command to obtain the changed second configuration information. The information to be changed in the second configuration information, for example, the corresponding identification information in the second configuration information, is the same information as the first identification information carried in the configuration information request command.

The write command carries the changed second configuration information and write address information, the write address information is to indicate a write location of the changed second configuration information in the memory device 610. The memory device 610 can write the changed second configuration information based on the write command, and then send the write result to the memory controller 620. For example, the memory device 610 includes a peripheral circuit and a memory array, the peripheral circuit in the memory device 610 can receive the write command, parse the changed second configuration information and the write address information from the write command, and write the changed second configuration information into the write location corresponding to the write address information in the memory array.

The write result is to indicate a result of writing the changed second configuration information into the memory device 610, and the content of the write result is not limited in some examples of the present disclosure. For example, the content of the write result may include, but is not limited to, a write status (for example, write success or write failure), write address information, a write timestamp, and the like. After receiving the write result, the memory controller 620 determines second reply information for indicating the write result, and sends the second reply information to the host.

The form of the second reply information is not limited in some examples of the present disclosure, as long as it is ensured that the host can extract the information that needs to be read from the second reply information, or that the host can learn the write result of writing the changed second configuration information into the memory device 610 based on the second reply information. For example, a form of the second reply information may be a message.

In some examples, the memory controller 620 is configured to: in response to the configuration information request command indicating to request to change information in the second configuration information, verify the configuration information request command, and if the verification passes, send the second reply information. When the configuration information request command indicates to request to change the information in the second configuration information, the configuration information request command is first verified, and after the verification passes, the information in the second configuration information is changed and the second reply information is sent to the host, to ensure the security of the information change.

The manner in which the configuration information request command is verified may be set according to experience, or may be flexibly adjusted according to actual scenarios, which is not limited in some examples of the present disclosure.

In some examples, verifying the configuration information request command includes at least one of grammar verification or permission verification on the configuration information request command. If only the grammar verification is performed on the configuration information request command, the verification pass means that the grammar verification passes; if only the permission verification is performed on the configuration information request command, the verification pass means that the permission verification passes; and if the grammar verification and the permission verification are performed on the configuration information request command, the verification pass means that the grammar verification passes and the permission verification passes.

For example, the process of performing grammar verification on the configuration information request command includes: checking the grammar of the configuration information request command according to the grammar rule, and if the grammar of the configuration information request command conforms to the grammar rule, determining that the grammar verification passes; and if the grammar of the configuration information request command does not conform to the grammar rule, determining that the grammar verification fails. The grammar rule may be set according to experience, or may be flexibly adjusted according to actual scenarios, which is not limited in some examples of the present disclosure.

For example, the process of performing permission verification on the configuration information request command includes: parsing the configuration information request command, determining identification information of the host, determining whether the host has permission to change the second configuration information according to the identification information of the host, and if the host has permission to change the second configuration information, the permission verification passes, and if the host does not have permission to change the second configuration information, the permission verification fails.

In some examples, the memory controller 620 compares the identification information of the device having the permission to change the second configuration information with the identification information of the host, and if the identification information of the device having the permission to change the second configuration information includes the identification information of the host, determines that the host has the permission to change the second configuration information; and if the identification information of the device having the permission to change the second configuration information does not include the identification information of the host, determine that the host does not have the permission to change the second configuration information. For example, the identification information of the device having the permission to change the second configuration information may be recorded in the firmware, and the memory controller 620 may learn the identification information of the device having the permission to change the second configuration information from the running firmware. For example, the identification information of the device having the permission to change the second configuration information may be stored in the buffer memory of the memory controller 620, and the memory controller 620 may extract the identification information of the device having the permission to change the second configuration information from the buffer memory.

In some examples, if the verification fails, the memory controller 620 may send prompt information of verification failure to the host.

In some examples, the memory controller 620 is further configured to: when the configuration information request command indicates to request the information in the first configuration information and the information in the second configuration information, send third reply information corresponding to the configuration information request command to the host, the third reply information is determined by the memory controller 620 through interaction with the memory device 610. The third reply information is the reply information sent by the memory controller 620 to the host when the configuration information request command indicates to request the information in the first configuration information and the information in the second configuration information.

For example, the process in which the memory controller 620 determines the third reply information may include: the memory controller 620 sends a read command to the memory device 610, and the read command instructs the memory device 610 to read the second configuration information; the memory device 610 reads the second configuration information based on the read command, and sends the second configuration information to the memory controller 620; and the memory controller 620 receives the second configuration information sent by the memory device 610, and stores the received second configuration information in the buffer memory. When the type of the configuration information request command is the request-to-read type (for example, the configuration information request command indicates to request to read the information in the first configuration information and the information in the second configuration information), the memory controller 620 extracts the information requested by the configuration information request command to read from the first configuration information recorded in the running firmware, extracts the information requested by the configuration information request command to read from the second configuration information stored in the buffer memory, and forms the third reply information based on the extracted information.

When the type of the configuration information request command is the request-to-change type (for example, the configuration information request command indicates to request to change the information in the first configuration information and the information in the second configuration information), the memory controller 620 changes the second configuration information stored in the buffer memory based on the configuration information request command to obtain the changed second configuration information; sends a write command to the memory device 610, the write command instructs the memory device 610 to write the changed second configuration information; the memory device 610 writes the changed second configuration information based on the write command, and sends a write result to the memory controller 620; and the memory controller 620 determines the third reply information based on the write result. In some examples, the manner in which the memory controller 620 determines the third reply information based on the write result may be as follows: the memory controller 620 uses the information including the first information and the second information as the third reply information, the first information is used to indicate a write result, and the second information is used to indicate that there is no permission to change the information in the first configuration information.

In some examples, the memory controller 620 is configured to: in response to the configuration information request command indicating to request to change the information in the first configuration information and the information in the second configuration information, verify the configuration information request command, and if the verification passes, send the third reply information.

In some examples, a manner in which the memory controller 620 sends the reply information (the first reply information, the second reply information, or the third reply information) to the host is that the memory controller 620 sends the reply information to the host through the first interface, the first interface is an interface that the memory controller 620 has for communicating with the host.

The timing of sending the reply information (the first reply information, the second reply information, or the third reply information) to the host by the memory controller 620 is not limited in some examples of the present disclosure. For example, when the memory controller 620 sends the reply information to the host, the memory controller 620 immediately sends the reply information to the host after determining the reply information.

For example, the timing of sending the reply information to the host by the memory controller 620 may also be as follows: the memory controller 620 may send the reply information to the host in response to receiving the reply command sent by the host. After a period of time after sending the configuration information request command, the host may send a reply command to the memory controller 620, the reply command instructs the memory controller 620 to send the reply information.

In an example, the operation of determining the reply information and sending the reply information to the host may be performed by a processor of the memory controller 620.

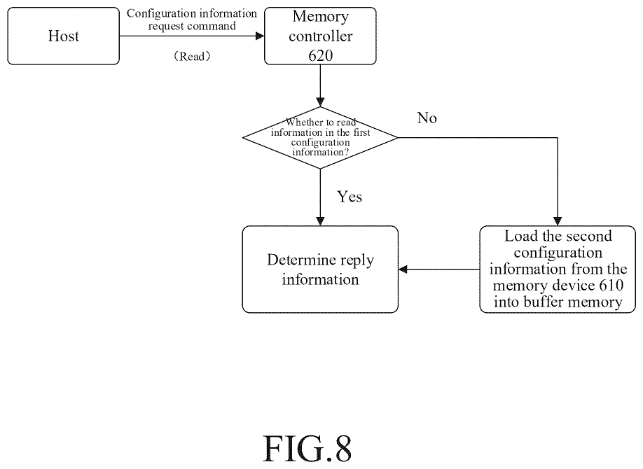

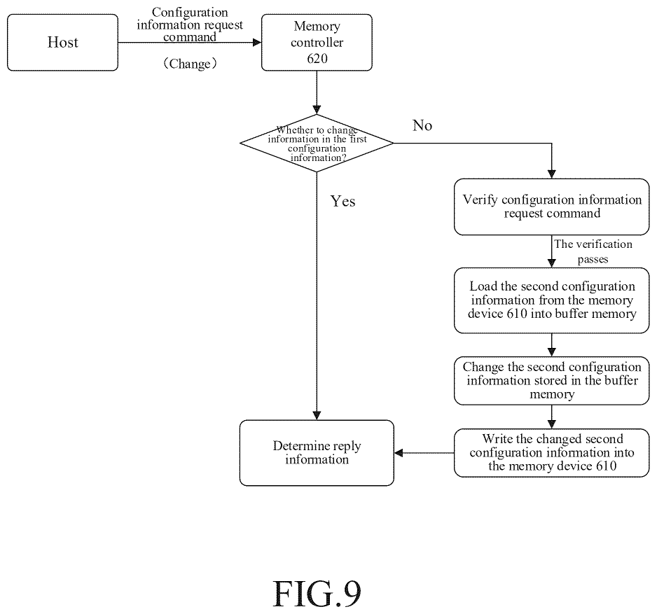

For example, the process of determining the reply information by the memory controller 620 may be shown in FIG. 8 and FIG. 9. FIG. 8 shows a process in which the memory controller 620 determines the reply information when the type of the configuration information request command sent by the host to the memory controller 620 is the request-to-read type. After receiving the configuration information request command of request-to-read type, the memory controller 620 determines whether the configuration information request command indicates to request to read the information in the first configuration information. When the configuration information request command indicates to request to read the information in the first configuration information, the memory controller 620 directly determines the reply information according to the first configuration information recorded in the firmware; and when the configuration information request command does not indicate to request to read the information in the first configuration information, the memory controller 620 loads the second configuration information from the memory device 610 into the buffer memory, and determines the reply information based on the second configuration information stored in the buffer memory.

FIG. 9 shows a process in which the memory controller 620 determines the reply information when the type of the configuration information request command sent by the host to the memory controller 620 is the request-to-change type. After receiving the configuration information request command of the request-to-change type, the memory controller 620 determines whether the configuration information request command indicates to request to change the information in the first configuration information. When the configuration information request command indicates to request to change the information in the first configuration information, the memory controller 620 directly uses the information used to indicate that there is no permission to change as the reply information; when the configuration information request command does not indicate to request to change the information in the first configuration information, the memory controller 620 verifies the configuration information request command. When the verification passes, the second configuration information is loaded into the buffer memory from the memory device 610, the second configuration information stored in the buffer memory is changed, the changed second configuration information is written into the memory device 610, and the information used to indicate the write result is used as the reply information.

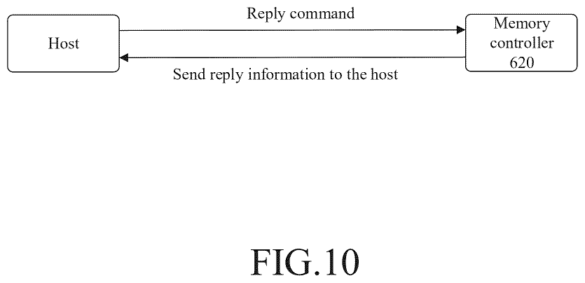

For example, the process in which the memory controller 620 sends the reply information to the host may be shown in FIG. 10. The host sends a reply command to the memory controller 620, and the memory controller 620 sends the reply information to the host in response to receiving the reply command.

In some examples of the present disclosure, the profile is divided into a changeable portion and an unchangeable portion, the changeable portion is separately loaded, and the unchangeable portion is recorded in the firmware. When the command sent by the host indicates to request the information in the unchangeable portion, the hardware (e.g., the processor) running the firmware in the memory controller 620 replies directly. When the command sent by the host indicates to request the information in the changeable portion, the changeable portion is first loaded into the internal buffer memory, and then the hardware (e.g., the processor) running the firmware replies according to the content in the buffer memory. Based on this manner, the unchangeable portion is not loaded, and only the changeable portion is loaded, it is beneficial to reduce the requirement of dynamically applying large amount of the internal memory resources, reduce the dependence on the internal memory resources significantly, save the memory resources, reduce the conflict with the FTL, and it is also beneficial to improve the loading efficiency of the profile, and further improve the use efficiency of the profile. In addition, the unchangeable portion does not need to be rewritten to the memory device 610, which is beneficial to reduce the amount of data written into the memory device 610 and prolong the service life of the memory device 610.

In some examples of the present disclosure, the unchangeable content (the first configuration information) in the profile is recorded in the firmware, and if receiving the configuration information request command indicating to request the information in the first configuration information after running the firmware, the memory controller 620 can independently determine the reply information according to the running firmware, for example, the process of determining the reply information does not need to interact with the memory device 610, the information in the memory device 610 does not need to be loaded into the memory controller 620, it is beneficial to improve the efficiency of determining the reply information, further improve the efficiency of sending the reply information, and improve the efficiency of interaction between the memory system 600 and the host.

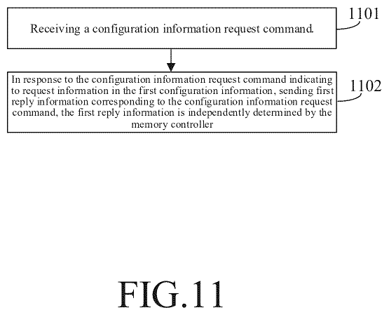

An example of the present disclosure provides a method of operating a memory system, the memory system includes a memory device and a memory controller coupled to the memory device. The operation method of the memory system may be performed by a memory controller. Firmware is run in the memory controller, first configuration information is recorded in the firmware, and is unchangeable content in the profile. Referring to FIG. 11, the operation method of the memory system includes operation 1101 and operation 1102.

Operation 1101: receiving a configuration information request command.

Operation 1102: in response to the configuration information request command indicating to request information in the first configuration information, sending first reply information corresponding to the configuration information request command, the first reply information is independently determined by the memory controller.

In some examples, the configuration information request command indicates to request to read information in the first configuration information, and the first reply information includes the information requested by the configuration information request command to read in the first configuration information.

In some examples, the configuration information request command indicates to request to change information in the first configuration information, and the first reply information indicates that there is no permission to change the information in the first configuration information.

In some examples, the memory device stores second configuration information, which is changeable content in the profile; the operation method of the memory system further includes: in response to the configuration information request command indicating to request information in the second configuration information, sending second reply information corresponding to the configuration information request command, the second reply information is determined by the memory controller through interaction with the memory device.

In some examples, the operation method of the memory system further includes: in response to the configuration information request command indicating to request information in the second configuration information, sending a read command to the memory device, the read command instructs the memory device to read the second configuration information; receiving the second configuration information sent by the memory device, and storing the received second configuration information in a buffer memory of the memory controller; and determining the second reply information based on the second configuration information stored in the buffer memory.

In some examples, the configuration information request command indicates to request to read information in the second configuration information, and the second reply information includes the information requested by the configuration information request command to read in the second configuration information stored in the buffer memory; or the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

In some examples, in response to the configuration information request command indicating to request the information in the second configuration information, sending the second reply information corresponding to the configuration information request command includes: in response to the configuration information request command indicating to request to change information in the second configuration information, verifying the configuration information request command, and if the verification passes, sending the second reply information.

In some examples, the configuration information request command carries first identification information, which is to identify information to be requested by the configuration information request command; and the configuration information request command indicating to request information in the first configuration information includes: the first identification information matches identification information corresponding to the information in the first configuration information.

In some examples, the profile includes a TCG profile.

The above description of the examples of the operation method of the memory system has the beneficial effects similar to the hardware example of the aforementioned memory system. For technical details not disclosed in the above examples of the operation method of the memory system, referring to the description of the hardware examples of the foregoing memory system in the present disclosure, and details are not described herein again.

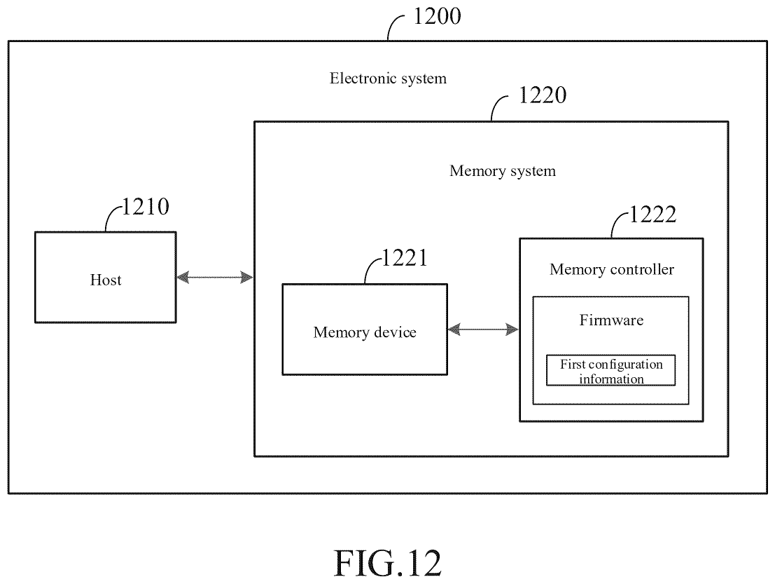

An example of the present disclosure provides an electronic system, as shown in FIG. 12, the electronic system 1200 includes a host 1210 and a memory system 1220 coupled to the host 1210, and the memory system 1220 includes a memory device 1221 and a memory controller 1222 coupled to the memory device 1221. The host 1210 may be the host 101 in FIG. 1, the memory system 1220 may be the memory system 102 in FIG. 1 and FIG. 5, or the memory system 600 in FIG. 6, the memory device 1221 may be the memory device 103 in FIG. 1 to FIG. 5 or the memory device 610 in FIG. 6, the memory controller 122 may be the memory controller 1 in FIG. 1 to FIG. 3, FIG. 5, or the memory controller 620 in FIG. 6.

Firmware is run in the memory controller 1222, first configuration information is recorded in the firmware, and is unchangeable content in the profile.

the host 1210 is configured to send a configuration information request command to the memory controller 1222; the memory controller 1222 is configured to: receive a configuration information request command; and in response to the configuration information request command indicating to request information in the first configuration information, send first reply information corresponding to the configuration information request command to the host 1210, the first reply information is independently determined by the memory controller 1222; the host 1210 is further configured to receive the first reply information.

In some examples, the configuration information request command indicates to request to read information in the first configuration information, and the first reply information includes the information requested by the configuration information request command to read in the first configuration information; or the configuration information request command indicates to request to change information in the first configuration information, and the first reply information indicates that there is no permission to change the information in the first configuration information.

In some examples, the memory device 1221 stores second configuration information, which is changeable content in the profile; the memory controller 1222 is further configured to: in response to the configuration information request command indicating to request information in the second configuration information, send second reply information corresponding to the configuration information request command to the host 1210, the second reply information is determined by the memory controller 1222 through interaction with the memory device 1221; and the host 1210 is further configured to receive the second reply information.

In some examples, the memory controller 1222 is further configured to: in response to the configuration information request command indicating to request information in the second configuration information, send a read command to the memory device 1221, the read command instructs the memory device 1221 to read the second configuration information; the memory device 1221 is configured to: read the second configuration information based on the read command, and send the second configuration information to the memory controller 1222; the memory controller 1222 is further configured to: receive the second configuration information sent by the memory device 1221, and store the received second configuration information in a buffer memory of the memory controller 1222; and determine the second reply information based on the second configuration information stored in the buffer memory.

In some examples, the configuration information request command indicates to request to read information in the second configuration information, and the second reply information includes the information requested by the configuration information request command to read in the second configuration information stored in the buffer memory; or the configuration information request command indicates to change information in the second configuration information, the second reply information indicates a write result of writing the changed second configuration information into the memory device 1221, and the changed second configuration information is obtained by changing the second configuration information stored in the buffer memory based on the configuration information request command.

In some examples, the memory controller 1222 is further configured to: in response to the configuration information request command indicating to request to change the information in the second configuration information, change the second configuration information stored in the buffer memory based on the configuration information request command to obtain the changed second configuration information; and send a write command to the memory device 1221. The write command instructs the memory device 1221 to write the changed second configuration information. The memory device 1221 is further configured to: write the changed second configuration information based on the write command, and send a write result to the memory controller 1222. The memory controller 1222 is further configured to: determine the second reply information based on the write result.

In some examples, the memory controller 1222 is further configured to: in response to the configuration information request command indicating to request to change information in the second configuration information, verify the configuration information request command, and if the verification passes, send the second reply information to the host 1210.

In some examples, the configuration information request command carries first identification information, which is to identify information to be requested by the configuration information request command. The configuration information request command indicating to request information in the first configuration information includes: the first identification information matches identification information corresponding to the information in the first configuration information.

In some examples, the profile includes a TCG profile.

The above description of the hardware example of the electronic system has the same beneficial effects as the hardware example of the aforementioned memory system. For technical details not disclosed in the hardware example of the foregoing electronic system, referring to the description of the hardware examples of the foregoing memory system in the present disclosure, and details are not described herein again.

An example of the present disclosure provides a non-transitory computer-readable storage medium, the non-transitory computer-readable storage medium stores firmware, and the firmware is loaded and run by a memory controller in a memory system to cause the memory controller implements the operation method of the memory system.

In some examples, the non-transitory computer-readable storage medium may be a storage medium such as a ferromagnetic random access memory (FRAM), a read only memory (ROM), a programmable read-only memory (PROM), an erasable programmable read-only memory (EPROM), an electrically erasable programmable read-only memory (EEPROM), a flash memory, a magnetic surface memory, an optical disc, or a compact disc read-only memory (CD-ROM); the non-transitory computer-readable storage medium may also include a combination of the foregoing plurality of storage mediums.

In some examples, the firmware may be written in the form of a program, software, software module, script, or code, written in any form of programming language (including compiled or interpreted languages, or declarative or procedural languages), and may be deployed in any form, including being deployed as a standalone program or as a module, component, subroutine, or other unit suitable for use in a computing environment.

It should be understood that “multiple” referred to herein means two or more. “and/or” describes an association relationship of an association object, and it indicates that there may be three relationships, for example, A and/or B may indicate that only A, both A and B, and only B. The character “/” generally indicates that the former and latter associated objects are a “or” relationship.

The above descriptions are merely examples of the present disclosure, and are not intended to limit the present disclosure, and any modifications, equivalent substitutions and improvements made within the principles of the present disclosure should be included within the protection scope of the present disclosure.

What is claimed is:

1. A memory system, comprising:
a memory device; and
a memory controller coupled with the memory device, wherein a firmware is run in the memory controller, first configuration information is recorded in the firmware and is unchangeable content in a profile, and the memory controller is configured to:
receive a configuration information request command; and
in response to the configuration information request command indicating to request information in the first configuration information, send first reply information corresponding to the configuration information request command, wherein the first reply information is independently determined by the memory controller.

2. The memory system of claim 1, wherein the configuration information request command indicates to request to read information in the first configuration information, and the first reply information comprises the information requested by the configuration information request command to read in the first configuration information; or
the configuration information request command indicates to request to change information in the first configuration information, and the first reply information indicates that there is no permission to change the information in the first configuration information.

3. The memory system of claim 1, wherein the memory device stores second configuration information which is changeable content in the profile, and the memory controller is further configured to:
in response to the configuration information request command indicating to request information in the second configuration information, send second reply information corresponding to the configuration information request command, wherein the second reply information is determined by the memory controller through interaction with the memory device.

4. The memory system of claim 3, wherein the memory controller is further configured to:
in response to the configuration information request command indicating to request information in the second configuration information, send a read command to the memory device, wherein the read command instructs the memory device to read the second configuration information;
receive the second configuration information sent by the memory device, and store the received second configuration information in a buffer memory of the memory controller; and
determine the second reply information based on the second configuration information stored in the buffer memory.

5. The memory system of claim 4, wherein the configuration information request command indicates to request to read information in the second configuration information, and the second reply information comprises the information requested by the configuration information request command to read in the second configuration information stored in the buffer memory; or
the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

6. The memory system of claim 3, wherein the memory controller is configured to:
in response to the configuration information request command indicating to request to change information in the second configuration information, verify the configuration information request command, and if the verification passes, send the second reply information.

7. The memory system of claim 1, wherein the configuration information request command carries first identification information which is to identify information to be requested by the configuration information request command; and
the configuration information request command indicating to request information in the first configuration information comprises: the first identification information matches identification information corresponding to the information in the first configuration information.

8. The memory system of claim 1, wherein the profile comprises a trusted computing group (TCG) profile.

9. A method of operating a memory system, wherein the memory system comprises a memory device and a memory controller coupled with the memory device, wherein a firmware is run in the memory controller, first configuration information is recorded in the firmware and is unchangeable content in a profile, and the method comprises:
receiving a configuration information request command; and
in response to the configuration information request command indicating to request information in the first configuration information, sending first reply information corresponding to the configuration information request command, wherein the first reply information is independently determined by the memory controller.

10. The method of claim 9, wherein the configuration information request command indicates to request to read information in the first configuration information, and the first reply information comprises the information requested by the configuration information request command to read in the first configuration information; or
the configuration information request command indicates to request to change information in the first configuration information, and the first reply information indicates that there is no permission to change the information in the first configuration information.

11. The method of claim 9, wherein the memory device stores second configuration information which is changeable content in the profile, and the method further comprises:
in response to the configuration information request command indicating to request information in the second configuration information, sending second reply information corresponding to the configuration information request command, wherein the second reply information is determined by the memory controller through interaction with the memory device.

12. The method of claim 11, further comprising:
in response to the configuration information request command indicating to request information in the second configuration information, sending a read command to the memory device, wherein the read command instructs the memory device to read the second configuration information;
receiving the second configuration information sent by the memory device, and storing the received second configuration information in a buffer memory of the memory controller; and
determining the second reply information based on the second configuration information stored in the buffer memory.

13. The method of claim 12, wherein the configuration information request command indicates to request to read information in the second configuration information, and the second reply information comprises the information requested by the configuration information request command to read in the second configuration information stored in the buffer memory; or
the configuration information request command indicates to change information in the second configuration information, the second reply information indicates a write result of writing the changed second configuration information into the memory device, and the changed second configuration information is obtained by changing the second configuration information stored in the buffer memory based on the configuration information request command.

14. The method of claim 11, wherein in response to the configuration information request command indicating to request information in the second configuration information, sending second reply information corresponding to the configuration information request command comprises:
in response to the configuration information request command indicating to request to change information in the second configuration information, verifying the configuration information request command, and if the verification passes, sending the second reply information.

15. The method of claim 9, wherein the configuration information request command carries first identification information, which is to identify information to be requested by the configuration information request command; and
the configuration information request command indicating to request information in the first configuration information comprises: the first identification information matches identification information corresponding to the information in the first configuration information.

16. The method of claim 9, wherein the profile comprises a trusted computing group (TCG) profile.

17. An electronic system, comprising:
a host configured to:
send a configuration information request command to a memory controller; and
receive first reply information; and
a memory system coupled with the host and comprising:
a memory device; and
the memory controller coupled with the memory device, wherein a firmware is run in the memory controller, first configuration information is recorded in the firmware and is unchangeable content in a profile, and the memory controller is configured to:
receive the configuration information request command; and
in response to the configuration information request command indicating to request information in the first configuration information, send the first reply information corresponding to the configuration information request command to the host, wherein the first reply information is independently determined by the memory controller.

18. The electronic system of claim 17, wherein the configuration information request command indicates to request to read information in the first configuration information, and the first reply information comprises the information requested by the configuration information request command to read in the first configuration information; or
the configuration information request command indicates to request to change information in the first configuration information, and the first reply information indicates that there is no permission to change the information in the first configuration information.

19. The electronic system of claim 17, wherein the memory device stores second configuration information which is changeable content in the profile,
the memory controller is further configured to: in response to the configuration information request command indicating to request information in the second configuration information, send second reply information corresponding to the configuration information request command to the host, wherein the second reply information is determined by the memory controller through interaction with the memory device; and
the host is further configured to receive the second reply information.

20. The electronic system of claim 19, wherein
the memory controller is further configured to: in response to the configuration information request command indicating to request information in the second configuration information, send a read command to the memory device, wherein the read command instructs the memory device to read the second configuration information;
the memory device is configured to: read the second configuration information based on the read command, and send the second configuration information to the memory controller; and
the memory controller is further configured to: receive the second configuration information sent by the memory device, store the received second configuration information in a buffer memory of the memory controller, and determine the second reply information based on the second configuration information stored in the buffer memory.
